(19) United States
(12) Patent Application Publication
(10) Pub. No.: US 2013/0058101 A1
(43) Pub. Date: Mar. 7, 2013

(54) NON-DISPONSABLE LED LAMP

(71) Applicant: Robert WANG, Taoyuan County (TW)

(72) Inventor: Robert WANG, Taoyuan County (TW)

(21) Appl. No.: 13/223,443

(22) Filed: Sep. 1, 2011

(51) Int. Cl. F21V 7/00

(52) U.S. Cl. 362/296.01

(57) ABSTRACT

A non-disposable LED lamp includes a main body, an LED unit disposed on the main body. The outer side of the LED unit is covered with a lampshade. A light-reflecting member is vertically provided in the lampshade. The light-reflecting member has a periphery side formed with a light-reflecting slanted surface which is taped toward the LED unit. When the LEDs is activated, part of the light will be reflected by the light-reflecting slanted surface to radiate light toward the whole lampshade, so the non-disposable LED lamp enables to radiate light in a pantoscopic way. The non-disposable LED lamp of the present invention can increase the radiating angle to provide an even illumination effect.

### BACKGROUND OF THE INVENTION

1. Field of the Invention

The present invention relates to non-disposable LED lamp.

2. Description of the Prior Art

LED is widely used on an illumination apparatus because it has low working voltage, a long life span, and no mercury pollution, instead of light bulbs and fluorescent lamps. As shown in FIG. 1, a conventional LED light bulb comprises a main body 1, an LED unit 2 coupled to the main body 1, and a lampshade 3 connected to an outer side of the LED unit. When the conventional LED light bulb is electrified, the LED unit 2 radiates light and the light penetrates through the lampshade 3 to achieve an illumination effect.

Referring to FIG. 1, the rays of the LEDs are direct light, so the radiating angle is small and the light is concentrated. Thus, when the conventional LED light bulb is electrified, the rays of the LED unit 2 are only toward the front of the lampshade 3, so there is no light to the sides and rear of the lampshade 3. The conventional LED light bulb is unable to provide an even illumination. Accordingly, the inventor of the present invention has devoted himself based on his many years of practical experiences to solve this problem.

### SUMMARY OF THE INVENTION

The primary object of the present invention is to provide a non-disposable LED lamp which can radiate in a pantascopic way to provide even illumination.

In order to achieve the aforesaid object, the non-disposable LED lamp of the present invention comprises a main body, an LED unit, a lampshade and a light-reflecting member. The LED unit is disposed on the main body. The lampshade is used to cover an outer side of the LED unit. The light-reflecting member is vertically disposed in the lampshade. The light-reflecting member has a periphery side formed with a light-reflecting slanted surface which is taped toward the LED unit.

When the non-disposable LED lamp of the present invention is switched on, the LEDs of the LED unit will illuminate. The rays of light are toward the light-reflecting member. Because the lampshade is provided with the light-reflecting member and the light-reflecting member has the light-reflecting slanted surface, part of the light will be reflected by the light-reflecting slanted surface to radiate toward the whole lampshade, so the non-disposable LED lamp enables to radiate light in a pantoscopic way. Thus, the non-disposable LED lamp of the present invention can increase the radiating angle to provide an even illumination effect.

### BRIEF DESCRIPTION OF THE DRAWINGS

FIG. 1 is a schematic view of a conventional LED light bulb when in use;

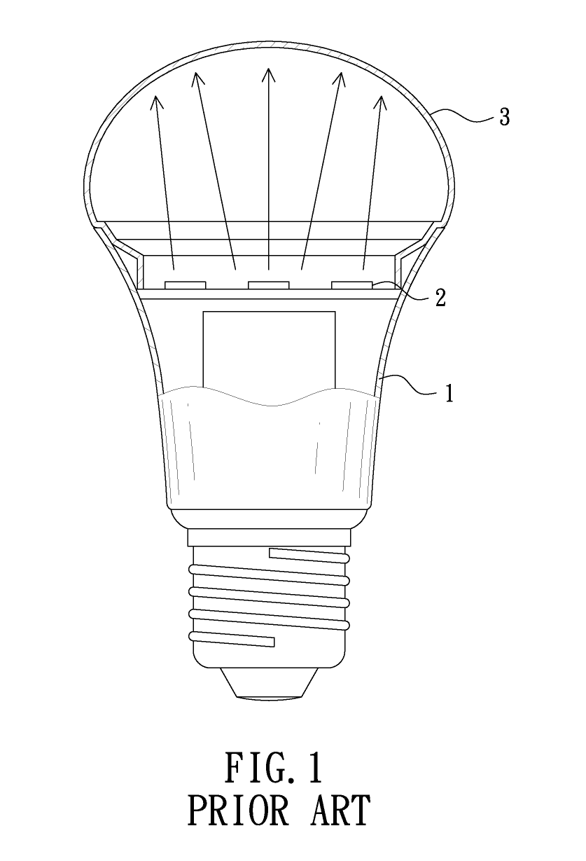

FIG. 2 is a perspective view according to a preferred embodiment of the present invention;

FIG. 3 is an exploded view according to the preferred embodiment of the present invention;

FIG. 4 is a sectional view according to the preferred embodiment of the present invention;

FIG. 5 is a schematic view of the preferred embodiment of the present invention when in use; and

FIG. 6 is a sectional view according to another preferred embodiment of the present invention.

### DETAILED DESCRIPTION OF THE PREFERRED EMBODIMENTS

Embodiments of the present invention will now be described, by way of example only, with reference to the accompanying drawings.

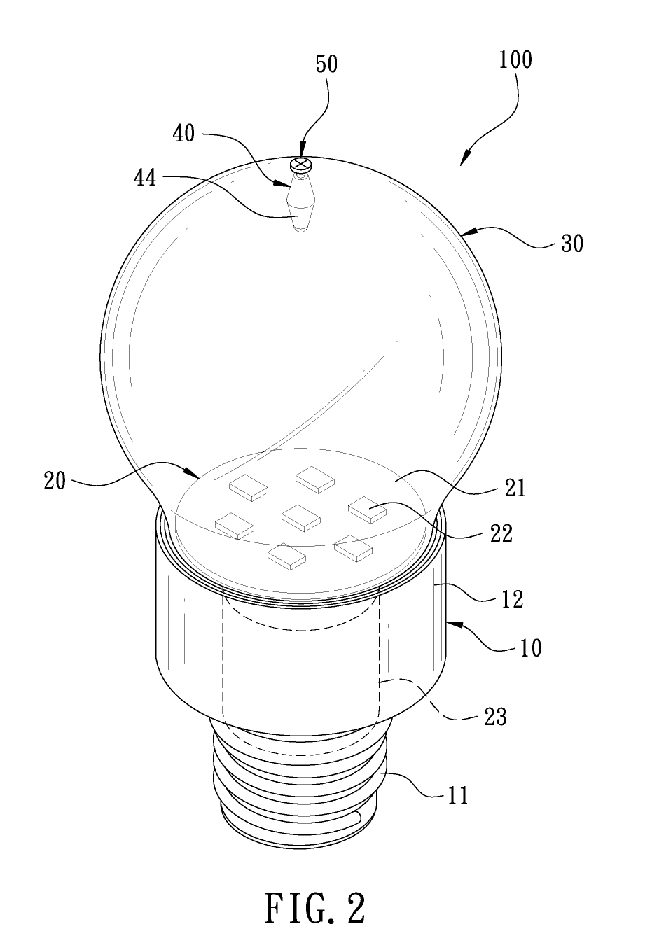

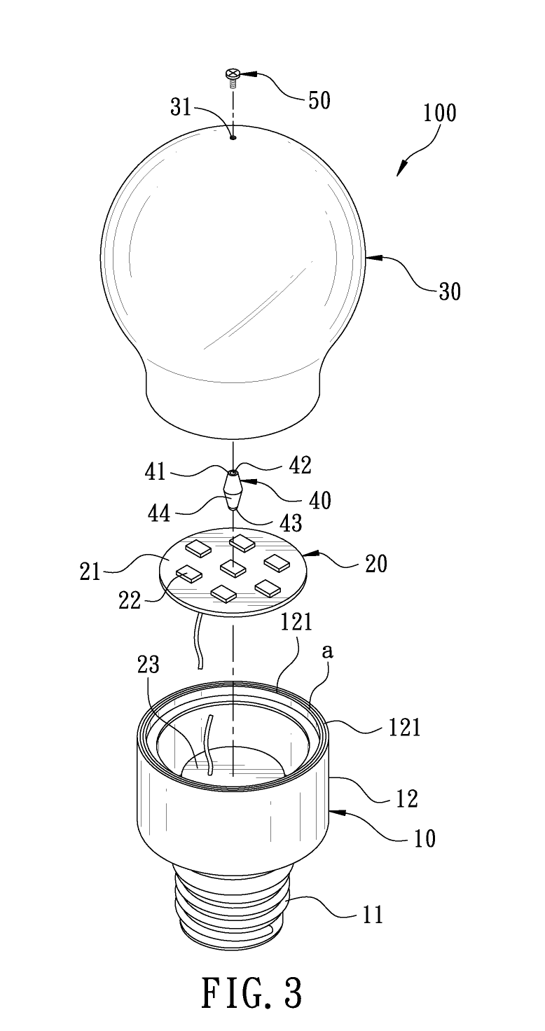

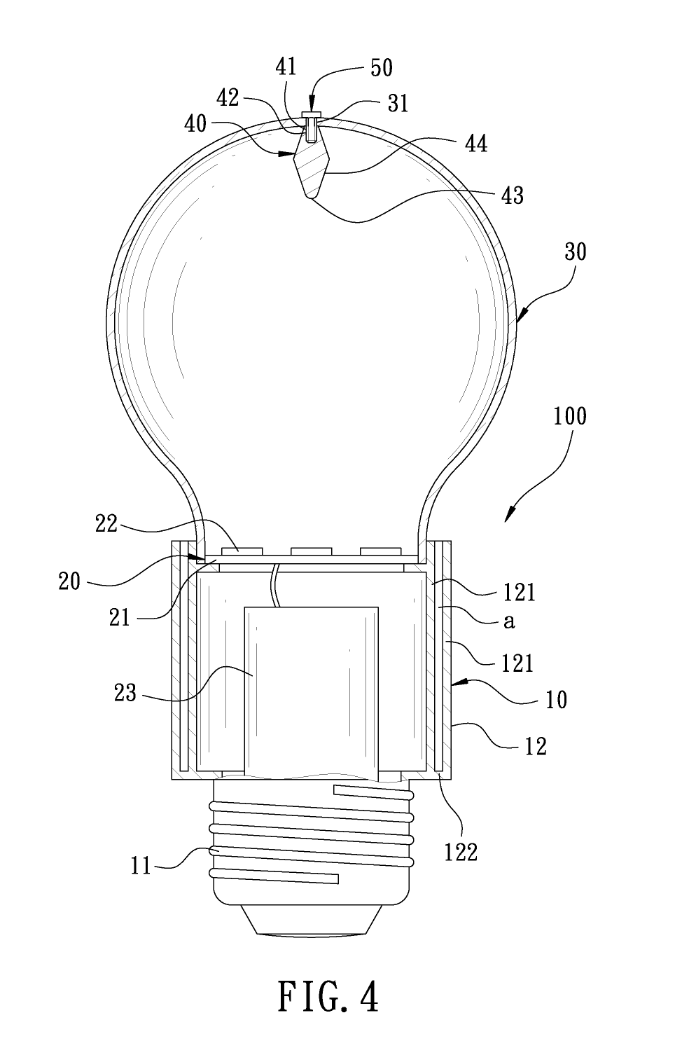

As shown in FIG. 2 through FIG. 4, the non-disposable LED lamp 100 according to a preferred embodiment of the present invention comprises a main body 10, an LED unit 20, a lampshade 30, and a light-reflecting member 40.

The main body 10 comprises a connecting head 11 to connect a corresponding lamp socket (not shown in the drawings), such as E27 lamp socket or MR16 lamp socket. In this embodiment, the connecting head 11 is adapted for E27 lamp socket. One end of the connecting head 11 is axially formed with a bearing part 12. The bearing part 12 comprises two metallic casings 121 which are connected through a connecting member 122. A gap a is defined between the two metallic casings 121. In the embodiment, the bearing part 12 is constituted by the two metallic casings 121 which are integrally formed with a connecting plate to form the connecting member 122.

The LED unit 20 is disposed on the main body 10. In this embodiment, the LED unit 20 comprises a circuit board 21 which is fixed to the bearing part 12. The circuit board 21 has a plurality of LEDs 22 thereon. The LED unit 20 further has a driving module 23. The driving module 23 is electrically connected between the connecting head 11 of the main body 10 and the circuit board 21 for activating the LEDs 22 to illuminate.

The lampshade 30 is used to cover an outer side of the LED unit 20. One end of the lampshade 30, opposite the LED unit 20, has a through hole 31.

The light-reflecting member 40 is vertically disposed in the lampshade 30. One end of the light-reflecting member 40 is a fixed end 41. The fixed end 41 is tapered toward the lampshade 30 to form a rhombus-like shape. The fixed end 41 has an end surface with a lock hole 42 corresponding to the through hole 31. A lock member 50, such as a bolt, is inserted through the through hole 31 and locked to the lock hole 42, such that the light-reflecting member 40 is secured to the inner wall of the lampshade 30. Another end of the light-reflecting member 40 is a free end 43 which is taped toward the LED unit 20. The free end 41 has a periphery side formed with a light-reflecting slanted surface 43.

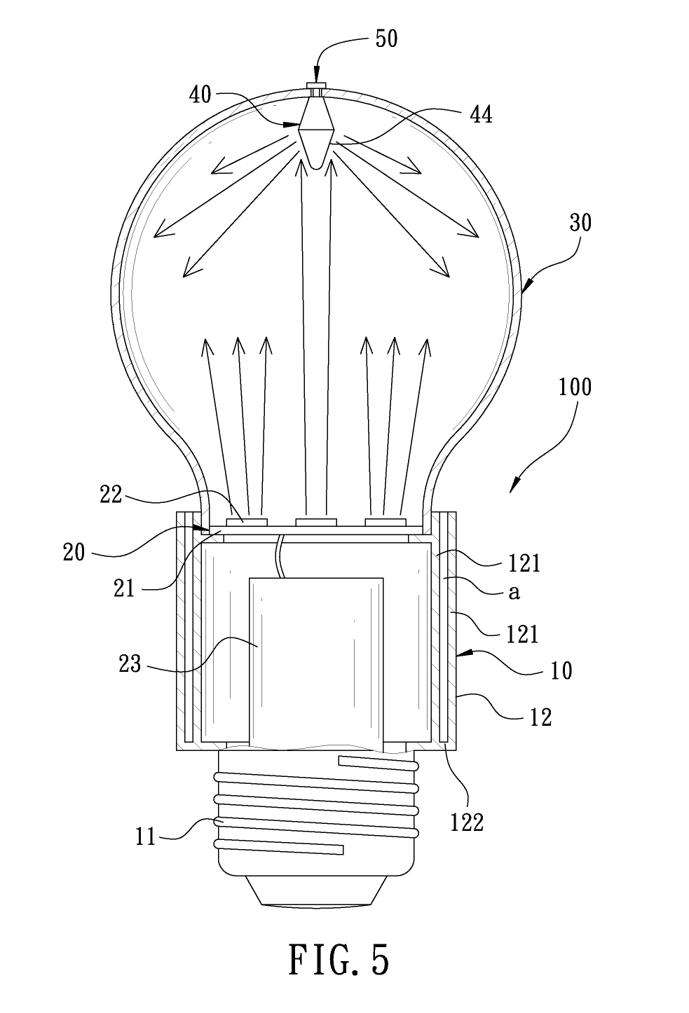

FIG. 5 is a schematic view of the preferred embodiment of the present invention when in use. When the non-disposable LED lamp 100 is switched on, the LEDs 22 of the LED unit 20 will illuminate. The light rays are toward the light-reflecting member 40. Because the lampshade 30 is provided with the light-reflecting member 40 and the light-reflecting member 40 has the light-reflecting slanted surface 44, part of the light will be reflected by the light-reflecting slanted surface 44 to radiate toward the whole lampshade 30, so the non-disposable LED lamp 100 enables to radiate light in a pantoscopic way. According to a real test, the maximum radiating angle of the conventional LED light bulb is about 180 degrees. The maximum radiating angle of the non-disposable LED lamp 100 of the present invention is about 270 degrees. Thus, the non-disposable LED lamp 100 of the present invention can increase the radiating angle to provide an even illumination effect.

It is noted that the fixed end 41 of the light-reflecting member 40 is tapered toward the lampshade 30 to form a rhombus-like shape to decrease light shadow on the lampshade 30 projected by the light-reflecting member 40, so it is not easy to find the existence of the light-reflecting member 40.

It is noted that the bearing part 12 of the main body 10 is constituted by the two metallic casings 121 which are connected through the connecting member 122 and between the metallic casings 121 is the gap a. This can greatly increase the area of the bearing part 12 to contact air so as to radiate heat from the LEDs 22, so the LEDs 22 can avoid thermal rurnway.

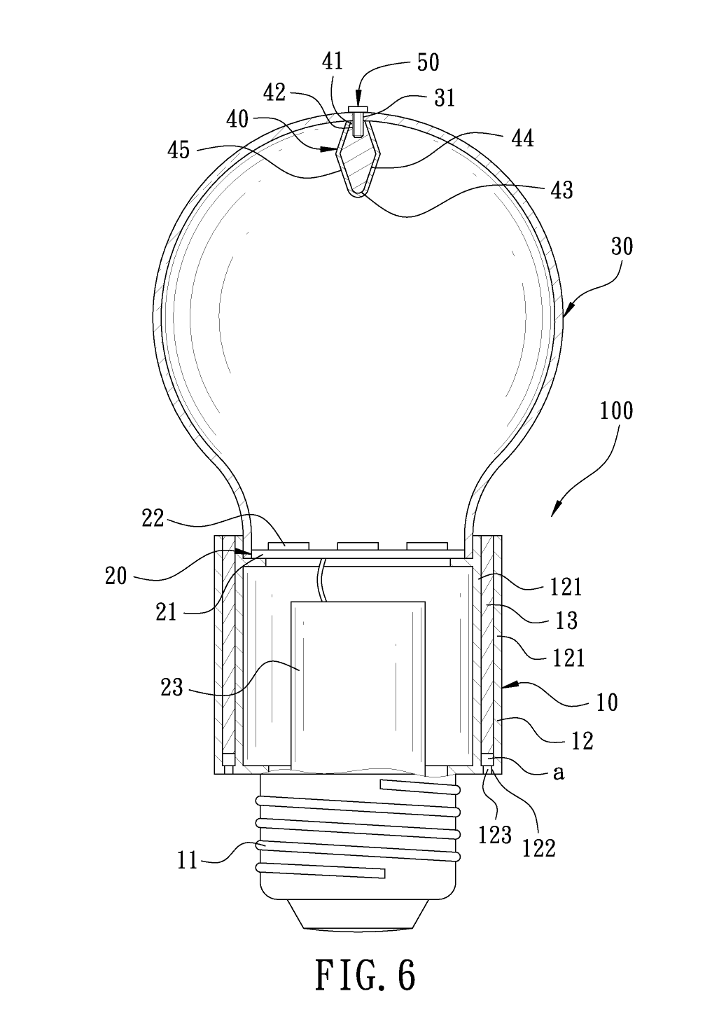

FIG. 6 is a sectional view according to another embodiment of the present invention, which is substantially similar to the aforesaid embodiment with the exceptions described hereinafter. The light-reflecting slanted surface 44 of the light-reflecting member 40 is provided with a light-reflecting layer 45, such as a chromate treatment layer, to enhance the light-reflecting capability of the light-reflecting slanted surface 44. The connecting member 122 of the main body 10 has a plurality of radiating holes 123 and a partition 13 is provided in the gap 1 to enhance the radiating capability of the bearing part 12, such that the LED unit 20 can be provided more LEDs 22 or to increase the power of the LEDs 22 to enhance illumination effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A non-disposable LED lamp, comprising:
a main body;
an LED unit disposed on the main body;
a lampshade used to cover an outer side of the LED unit; and
a light-reflecting member vertically disposed in the lampshade, the light-reflecting member having a periphery side formed with a light-reflecting slanted surface which is taped toward the LED unit.

2. The non-disposable LED lamp as claimed in claim 1, wherein one end of the light-reflecting member is a fixed end which is secured to an inner wall of the lampshade and another end of the light-reflecting member is a free end which is taped toward the LED unit, the free end having a periphery side formed with the light-reflecting slanted surface.

3. The non-disposable LED lamp as claimed in claim 2, wherein the fixed end is tapered toward the lampshade to form a rhombus-like shape.

4. The non-disposable LED lamp as claimed in claim 2, wherein the lampshade has a through hole, the fixed end of the light-reflecting member having a lock hole corresponding to the through hole, a lock member inserted through the through hole and locked to the lock hole so that the light-reflecting member is secured to the inner wall of the lampshade.

5. The non-disposable LED lamp as claimed in claim 1, wherein the light-reflecting slanted surface of the light-reflecting member is provided with a light-reflecting layer.

6. The non-disposable LED lamp as claimed in claim 1, wherein the main body comprises a connecting head, the connecting head being axially formed with a bearing part, the bearing part being adapted to couple with the LED unit.

7. The non-disposable LED lamp as claimed in claim 6, wherein the bearing part comprises two metallic casings which are connected through a connecting member, a gap defined between the two metallic casings.

8. The non-disposable LED lamp as claimed in claim 7, wherein the connecting member has a plurality of radiating holes.

9. The non-disposable LED lamp as claimed in claim 7, wherein a partition is provided in the gap.
